(19) United States
(12) Patent Application Publication
(10) Pub. No.: US 2011/0303593 A1
(43) Pub. Date: Dec. 15, 2011

(54) Fitting Element with Grip Force Distributor

(75) Inventor: Thomas Reinhardt, Waldbronn (DE)

(73) Assignee: AGILENT TECHNOLOGIES, INC., Santa Clara, CA (US)

(21) Appl. No.: 13/106,518

(22) Filed: May 12, 2011

(30) Foreign Application Priority Data
Jun. 14, 2010 (GB) 1009845.7

(51) Int. Cl. B01D 15/08; F16L 21/04

(52) U.S. Cl. 210/143; 285/399; 285/342; 210/198.2

(57) ABSTRACT

A fitting element, in particular for an HPLC application, is configured for providing a fluidic coupling of a tubing to a fluidic device. The fitting element includes a gripping piece configured to exert, upon coupling of the tubing to the fluidic device, a grip force between the fitting element and the tubing. The gripping piece includes a grip force distributor configured to transform an axial force, provided in an axial direction with respect to the tubing, into a plurality of individual grip force components, each grip force component is exerting on the tubing spaced apart in the axial direction from another grip force component, and the plurality of individual grip force components result in the grip force.

This application claims priority from United Kingdom Patent Application, No. GB 1009845.7 filed on 14 Jun. 2010, which is incorporated by reference in its entirety.

The present invention relates to a fitting element for a fluidic device, in particular in a high performance liquid chromatography application.

### BACKGROUND

In high performance liquid chromatography (HPLC), a liquid has to be provided usually at a very controlled flow rate (e.g. in the range of microliters to milliliters per minute) and at high pressure (typically 20-100 MPa, 200-1000 bar, and beyond up to currently 200 MPa, 2000 bar) at which compressibility of the liquid becomes noticeable. For liquid separation in an HPLC system, a mobile phase comprising a sample fluid with compounds to be separated is driven through a stationary phase (such as a chromatographic column), thus separating different compounds of the sample fluid which may then be identified.

The mobile phase, for example a solvent, is pumped under high pressure typically through a column of packing medium (also referred to as packing material), and the sample (e.g. a chemical or biological mixture) to be analyzed is injected into the column. As the sample passes through the column with the liquid, the different compounds, each one having a different affinity for the packing medium, move through the column at different speeds. Those compounds having greater affinity for the packing medium move more slowly through the column than those having less affinity, and this speed differential results in the compounds being separated from one another as they pass through the column.

The mobile phase with the separated compounds exits the column and passes through a detector, which identifies the molecules, for example by spectrophotometric absorbance measurements. A two-dimensional plot of the detector measurements against elution time or volume, known as a chromatogram, may be made, and from the chromatogram the compounds may be identified. For each compound, the chromatogram displays a separate curve or “peak”. Effective separation of the compounds by the column is advantageous because it provides for measurements yielding well defined peaks having sharp maxima inflection points and narrow base widths, allowing excellent resolution and reliable identification of the mixture constituents. Broad peaks, caused by poor column performance, so called “Internal Band Broadening” or poor system performance, so called “External Band Broadening” are undesirable as they may allow minor components of the mixture to be masked by major components and go unidentified.

An HPLC column typically comprises a stainless steel tube having a bore containing a packing medium comprising, for example, silane derivatized silica spheres having a diameter between 0.5 to 50 μm, or 1-10 μm or even 1-7 μm. The medium is packed under pressure in highly uniform layers which ensure a uniform flow of the transport liquid and the sample through the column to promote effective separation of the sample constituents. The packing medium is contained within the bore by porous plugs, known as “frits”, positioned at opposite ends of the tube. The porous frits allow the transport liquid and the chemical sample to pass while retaining the packing medium within the bore. After being filled, the column may be coupled or connected to other elements (like a control unit, a pump, containers including samples to be analyzed) by e.g. using fitting elements. Such fitting elements may contain porous parts such as screens or frit elements.

During operation, a flow of the mobile phase traverses the column filled with the stationary phase, and due to the physical interaction between the mobile and the stationary phase a separation of different compounds or components may be achieved. In case the mobile phase contains the sample fluid, the separation characteristics is usually adapted in order to separate compounds of such sample fluid. The term compound, as used herein, shall cover compounds which might comprise one or more different components. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high pressure occurs across the column.

Fittings for coupling different components, such as separation columns and conduits, of fluidic devices are commercially available and are offered, for instance, by the company Swagelok (see for instance http://www.swagelok.com). A typical tube fitting is disclosed in U.S. Pat. No. 5,074,599 A.

U.S. Pat. No. 6,494,500 discloses a self-adjusting high pressure liquid connector for use with high pressure liquid chromatography (HPLC) columns requiring liquid-tight and leak free seals between fittings and unions.

WO 2005/084337 discloses a coupling element (330) comprising a male sealing element. The male sealing element may have a generally cylindrical shape, and defines a fluid passageway therethrough for the transmission of fluid. The male sealing element is secured to a ferrule which is located within a cavity of the nut. The coupling element (330) also has a biasing element disposed between a retaining ring and the ferrule located within the nut cavity. This biasing element facilitates a fluid-tight, metal to metal (or metal to plastic, or plastic to plastic) seal between the male sealing element and female sealing element.

WO 2009/088663 A1 discloses liquid-chromatography conduit assemblies having high-pressure seals. A fluid-tight seal, proximal to the joint between two conduits, is provided, for example, through use of pressure, while a stabilizing seal, distal to the joint, is provided by adhering the conduits to the tube.

A high pressure connect fitting is disclosed at US 2008/0237112 A1. A tip of a seal contacts the walls of a tapered sealing cavity to form a primary seal. The volume of space between the very end of the tip and the end of a sealing cavity defines a dead space. As the seal is axially compressed within an annular recess, the tip engages the walls of the tapered sealing cavity to form the primary seal, and further deforms to occupy space otherwise associated with the dead space. As the tip of the seal engages the tapered sealing cavity, the end face of the seal compresses against the end of the annular recess to form a secondary seal extending radially around the tip of the seal.

WO 2010/000324 A1, by the same applicant, discloses a fitting for coupling a tubing to another component of a fluidic device. The fitting comprises a male piece having a front ferrule and a back ferrule both being slidable on the tubing. The male piece has a first joint element configured slidably on the tubing. A female piece has a recess configured for accommodating the front ferrule and the tubing, and a second joint element configured to be joinable to the first joint element. The back ferrule is configured in such a manner that, upon joining the first joint element to the second joint element, the back ferrule exerts a pressing force on the front ferrule to provide a sealing between the front ferrule and the female piece, and the back ferrule exerts a grip force between the male piece and the tubing.

International Patent Application PCT/EP2010/055971 [Attorney Reference 20100019-01] discloses a fitting element, in particular for an HPLC application, configured for providing a fluidic coupling of a tubing to a fluidic device. The fitting element comprises a gripping piece to exert—upon coupling of the tubing to the fluidic device—a grip force between the fitting element and the tubing. The gripping piece comprises a hydraulic element configured to transform an axial force into a hydraulic pressure within the hydraulic element. The hydraulic pressure in the hydraulic element causes the grip force.

### SUMMARY

It is an object of the invention to provide an improved fitting, in particular for HPLC applications. The object is solved by the independent claim(s). Further embodiments are shown by the dependent claim(s).

According to embodiments of the present invention, a fitting element is provided, in particular for an HPLC application. The fitting element is configured for providing a fluidic coupling of a tubing to a fluidic device. The fitting element comprises a gripping piece configured to exert a grip force between the fitting element and the tubing, when the tubing is coupled to the fluidic device. The gripping piece promotes the grip force to mechanically connect the gripping element with the tubing, when the tubing is coupled to the fluidic device. The gripping piece comprises a grip force distributor configured to transform an axial force, which is provided in an axial direction with respect to the tubing, into a plurality of individual grip force components. Each grip force component is exerting on the tubing spaced apart in the axial direction from another grip force component. The plurality of individual grip force component result in the grip force.

The grip force distributor according to embodiments of the invention allows to provide a distribution of the grip force in the axial direction, for examples similar to the hydraulic element of the aforementioned International Patent Application PCT/EP2010/055971 [Attorney Reference 20100019-01]. This is in contrast to prior art solutions, wherein the grip force is applied in one location or position only, typically with a certain force distribution profile e.g. resulting from the contact pressure. By applying plural and axially spaced apart individual grip force components, with each individual grip force component applying at a different position in axial direction and typically also having a force distribution profile in axial direction (e.g. resulting from the contact pressure), embodiments of the present invention allow to better design and/or control the thus resulting grip force distribution profile. For example, the resulting grip force distribution profile can be designed to be substantially flat (or rippled dependent on the resolution and the distance between the individual grip force component) or having any other shaping dependent on the number of grip force components as well as their respective force distribution profiles. Accordingly, the grip force can be distributed over a wider region and excessive values of the grip force may be avoided.

In embodiments, the grip force distributor comprises an elastic spring element which is configured for varying its dimension (e.g. its lateral extension) in a radial direction (with respect to the tubing) under the influence of the axial force. Alternatively or in addition, the elastic spring element may comprise a plurality of angular elements, with each angular element being arranged in an angle with respect to the radial direction and being configured to decrease such an angle under the influence of an increase in the axial force. When decreasing the angle, the resulting height in radial direction of the angular element increases, so that accordingly the dimension of the grip force distributor increases in radial direction. When the grip force distributor is located or configured that it cannot dodge away in radial direction from the tubing, the increasing dimension in radial direction will therefore lead to an increased radial force (the grip force components) where the grip force distributor abuts to or at least towards the tubing.

The elastic spring element may comprise a mechanical spring element, which may be or comprise one or more of a group comprising: a spring washer, a disk spring, a Belleville spring washer, a bellow, a corrugated bellow, a metal bellow, a gaiter, a coupled ring-structure, a sheet metal packed, a spiral coil, or the like.

The elastic spring element may comprise a multiple spring configuration, for example to disk springs in parallel or mirrored.

The grip force distributor can be made of or comprise any kind of an elastic, non-floating material. As examples, a metal, preferably a spring steel, stainless steel (SST), nickel, etc., or an elastomer can be applied. Alternatively or in addition, a gas volume in a cavity, a liquid in a cavity, and/or a combination of plural of solid, and/or gaseous, and/or liquid materials can also be applied.

In embodiments, the gripping piece comprises a housing for housing the grip force distributor, which may be embodied by one or more pieces.

In one embodiment, the fitting element comprises a first housing element and a second housing element. Each housing element is configured as an individual component with respect to the other. Both, the first housing element and the second housing element, are configured to at least partly house the gripping piece, in particular the grip force distributor.

In one embodiment, at least one of the first housing element and the second housing element comprises a coupling element, which is configured to couple the first housing element and the second housing element, when the tubing is decoupled from the fluidic device and the second housing element is moved in axial direction with respect to the tubing. The coupling element thus provides a pull-out feature and/or de-assembly aid and can allow that the first housing element is held by the second housing element, when the second housing element is removed. This can ensure that the first housing element will not stick with either one of the tubing or fluidic device, when opening the fitting element and separating the tubing from the fluidic device, so that the first housing element can removed from the fluidic device (e.g. a receiving cavity thereof).

In one embodiment, the gripping piece is configured for generating a spring-biased force upon coupling of the tubing to the fluidic device. The term “spring-biased force” can be understood as a force, which is still exerted on an object in similar size even when the object is displaced—within certain limitations. The spring-biased force may also be an elastic and/or a spring-loaded force.

The spring-biased force can be exerted in an axial and/or radial direction. Axial direction shall mean a direction of an axial elongation of the tubing or parallel thereto. Radial shall mean a direction perpendicular to the axial elongation of the tubing or parallel thereto. Radial can also mean the radial elongation of the tubing.

The gripping piece can be configured for exerting the spring-biased force in radial direction of the tubing in order to provide a spring-biased grip force onto the tubing. This can be of advantage in order to compensate for mechanical tolerances, creeping of elements involved, and/or dynamic behavior of the system. In particular dynamic effects of the mobile phase may thus be compensated. Alternatively or in addition, the gripping piece may be configured for exerting the spring-biased force in axial direction on the tubing in order to provide a spring-biased coupling of the tubing to the fluidic device. In particular, a spring biased-pressing force on a front-side of the tubing can thus be achieved. This can promote a forward motion of the tubing towards the fluidic device. The spring-biased force in axial direction on the tubing may also allow compensating for mechanical tolerances or dynamic behavior, in particular caused by pressure variations in the fluid conducted by the tubing. In HPLC, such pressure variations often result from switching a sample loop into the flow path between the pump and the column.

Alternatively or in addition, the gripping piece can be configured for exerting the spring-biased force in axial direction on a sealing piece in order to provide a spring-biased sealing between the sealing piece and the fluidic device. The sealing piece can provide a fluid tight sealing in order to seal the fluid under high pressure in the tubing against ambient (i.e. outside the tubing). Again, the spring-bias may allow compensating mechanical tolerances and/or dynamic behavior of components involved. The spring-biased force can be generated by a mechanical spring element such as a spring washer, a disc spring. A multi spring configuration might be used, for example to disc spring separated by a flat spring. Alternatively or in addition, an elastic shaping can be provided to generate the spring biased force. For example, the gripping piece and/or the hydraulic element (in particular a housing thereof) can be shaped adequately to generate the spring biased force.

In one embodiment, the fitting element comprises a sealing piece configured to provide a sealing between the sealing piece and the fluidic device, when the tubing is coupled to the fluidic device. The sealing piece may be or comprise a front ferrule, for example as disclosed in the introductory part of the description such as by the aforementioned WO 2010/000324 A1, which teaching with respect to the sealing piece shall be incorporated herein by reference. The gripping piece may exert a pressing force against the sealing piece, which may be at least partially caused by the hydraulic pressure of the hydraulic element. The pressing force may be spring-biased in particular to address dynamic behavior of the system. The sealing piece can be provided slidable on the tubing, at least before coupling of the tubing to the fluidic device. This can allow to easily move the sealing piece into its intended position for sealing.

The sealing piece may have a conically tapered front part configured to correspond to a conical portion of a receiving cavity of the fluidic device. Upon coupling of the tubing to the fluidic device, the conically tapered front part may press against the conical portion of the receiving cavity for sealing against a pressure in a fluid part of the tubing.

Embodiments of the sealing piece are configured to prevent notches, marks or other permanent, non-elastic deformations to the tubing in order to ensure multiple use of the fitting.

In one embodiment, the fitting element comprises a front sealing configured to provide a sealing between a front side of the tubing and the fluidic device, when the tubing couples to the fluidic device. Such front sealing may in particular be a sealing in addition to the sealing provided by the sealing piece, but may also be an alternative thereto. In a preferred embodiment, the front sealing can be provided by an inlay comprised in a cavity of the front side of the tubing, such as disclosed in non-published international application PCT/EP2009/067646 [attorney ref. 20100015], which teaching with respect to the inlay shall be incorporated herein by reference.

In one embodiment, wherein the fitting element comprises the sealing piece (configured for sealing against a pressure in the fluid part of the tubing) and a front sealing, the fitting element provides a two-stage sealing with the front sealing sealing directly where the tubing couples to the fluidic device, and the sealing piece providing an additional sealing stage in order to securely sealing against a fluid pressure in the fluid path. In other words, the front sealing may provide a low(er) pressure sealing at the front side of the tubing, and the sealing piece may provide a high(er) pressure sealing located, for example, at or along a lateral side of the tubing.

It is to be understood that the front side at the connection of the tubing to the fluidic device is often very difficult to seal, as in particular the shape of the counterpart element to the tubing might vary from one fluidic device to another and/or might have surface imperfections. However, contact pressure in particular in axial direction of the tubing might be limited in order to avoid or reduce destruction or deformation of the components involved. With increasing fluid pressure, for example in the range of thousand bar and beyond, conventional fitting systems have been often shown not to be sufficient and may lead to leaking and/or cross contamination. The two-stage sealing, however, may allow that fluid even when “leaking” through the first stage of the front sealing is fully sealed at the second stage and is limited from returning back into the fluid path, for example during normal application.

For example in an HPLC application, the front sealing may allow fluid to pass (“leak”) during pressurizing of the system (when the pressure in the system is raised to the desired target pressure). While the sealing piece fully seals so that no fluid can leak through such sealing piece, an interspace between the first and second sealing stages may become filled with fluid. However, as such fluid applied in the pressurizing phase in HPLC is normally only solvent which does not contain any sample, the interspace between the first and second stages will thus be filled only with such (non sample containing) solvent, so that no sample contamination can occur even when fluid contained in the inner space may return back into the fluid path. Further, it is to be understood that system pressure after sample is introduced in HPLC usually changes slowly and within a narrow range compared to the system pressure. so that the fluid in the interspace, is kept within the interspace and “sees” only very low “driving force” to communicate with the fluidic path of the inside of the tubing. Such embodiments thus provide a “chromatographic sealing” at the front side by means of the front sealing and a “system pressure sealing” by means of the sealing piece. The term “chromatographic sealing” can be understood as a sealing sufficient during a sample run in an HPLC system, so that carry over (i.e. the sample is temporally trapped and released later), or external band broadening (e.g. sample is guided to a “dead space” where the sample is released only by diffusion) can be avoided or at least limited, preferably while maintaining pressure within a narrow range when sample has been introduced in the HPLC-System.

In one embodiment, the fitting element comprises a first joint element configured for exerting the axial force on the hydraulic element, when the tubing is coupled to the fluidic device. The first joint element can be joined to a second joint element of the fluidic device, for example by a screw connection. The first joint element may be provided slidable on the tubing, at least before coupling of the tubing to fluidic device, so that the first joint element can be easily moved into its desired position. The first joint element may partly house the hydraulic element, for example by providing at least one side enclosing the hydraulic element.

The axial force, as exerting on the hydraulic element, can be converted in a radial direction perpendicular to an axial elongation of the tubing. The axial force may result from coupling of the tubing to the fluidic device, for example from joining the joint elements together.

The fitting element can be configured to become accommodated by a receiving cavity of the fluidic device, for example in accordance with embodiments as disclosed by the documents cited in the introductory part of the description, which teaching with respect to accommodating the fitting element shall be incorporated herein by reference.

The gripping force can be in a radial direction with respect to the tubing.

In embodiments, the gripping piece is or comprises a back ferrule and/or may be slidable on the tubing at least before coupling of the tubing to the fluidic device, so that the gripping piece can easily be moved into its desired position. This can be in accordance with embodiments as disclosed by documents cited in the introductory part of the description, which teaching with respect to such mechanical aspects of the gripping piece (e.g. back ferrule or slidability) shall be incorporated herein by reference.

In embodiments, the tubing is made of or comprises a metal, stainless steel, titan, plastic, polymer, ceramic, glass and/or quartz. The tubing may have a lumen having a diameter of less than 0.8 mm, particularly less than 0.2 mm. The tubing may have circular, elliptical, rectangular or any other suitable shape as known in the art and may also show variations in diameter and/or shaping. The tubing may be or comprise a capillary. The tubing may also be provided by a planar structure as disclosed e.g. in WO2009/121410A1 by the same applicant.

In one embodiment, the tubing comprises an inner tubing and an outer tubing. The outer tubing (radially) surrounds the inner tubing. The inner tubing may be comprised of a material different from the outer tubing. The outer tubing may be a socket for adapting to a desired outer diameter for the tubing and/or specific requirements for further tightening elements e.g. ferrules.

The terms “fitting” and “fitting element”, as used herein, shall both relate to coupling a tubing to a fluidic device. The term “fitting” shall cover all components required for coupling the tubing to the fluidic device, and may even comprise the tubing and/or the fluidic device, or parts thereof. The term “fitting element” shall cover a part of the fitting.

The terms “axial” and “radial”, as used herein, shall not be limited to circular embodiments of the tubing only but shall cover any kind of shaping of the tubing including rectangular tubings such as in planar structures. The term “axial” shall be interpreted as being in a direction of the elongation of the tubing, which typically also represents the direction of fluid flow in the tubing. Accordingly, the term “radial” shall be interpreted as being in a direction of the lateral dimension of the tubing and being essentially perpendicular to the direction of the elongation of the tubing. Though most embodiments are described herein with respect to circular type of tubings, it goes without saying that they can be adapted accordingly to any other shaping, in particular rectangular tubings.

In an embodiment of the fitting, the fitting element comprises a front ferrule, a back ferrule, and a first joint element. The receiving cavity of the fluidic device is configured for accommodating the front ferrule and the tubing and has a second joint element configured to be joinable to the first joint element of the fitting element. The back ferrule is configured in such a manner that—upon joining the first joint element to the second joint element—the back ferrule exerts a spring-biased pressing force against the front ferrule to provide a sealing between the front ferrule and the receiving cavity. Further upon joining the first and second joined elements, the back ferrule exerts a grip force on the tubing.

In such embodiment, the front ferrule, the back ferrule, and the first joint element may be configured slidable on the tubing, at least before the tubing is coupled to the fluidic device. The receiving cavity may be configured for accommodating the back ferrule and a part of the first joining element. The fitting element may comprise an additional spring element arranged slidable on the tubing between the back ferrule and first joining element to transmit a force exerted by the first joint element to back ferrule.

Any of the sealing piece, the front ferrule, the back ferrule, spring elements, and the joint element may be embodied as disclosed by the documents cited in the introductory part of the description and in particular in the aforementioned WO 2010/000324 A1, which teaching with respect to the front ferrule shall be incorporated herein by reference.

The term “fluidic device” as used herein may cover or refer to a tubing or an apparatus such as an HPLC device, a fluid separation device, a fluid handling device, and/or a measurement device in general. Accordingly, embodiments of the invention cover couplings between individual tubings as well as couplings between a tubing and a device/apparatus.

The fluidic device may comprise a processing element configured for interacting with a sample fluid. The fluidic device may be configured to conduct a sample fluid through the fluidic device, a fluid separation system for separating compounds of a sample fluid, a fluid purification system for purifying a sample fluid, and/or to analyze at least one physical, chemical and/or biological parameter of at least one compound of a sample fluid.

According to embodiments of the present invention, a fitting element is provided, in particular for an HPLC application. The fitting element is configured for providing a fluidic coupling of a tubing to a fluidic device. The fitting element comprises a gripping piece configured to exert a grip force between the fitting element and the tubing, when the tubing is coupled to the fluidic device. The gripping piece promotes the grip force to mechanically connect the gripping element with the tubing, when the tubing is coupled to the fluidic device. The fitting element further comprises a first housing element and a second housing element. Each housing element is configured as an individual component with respect to the other. Both, the first housing element and the second housing element, are configured to at least partly house the gripping piece, in particular the grip force distributor. At least one of the first housing element and the second housing element comprises a coupling element, which is configured to couple the first housing element and the second housing element, when the tubing is decoupled from the fluidic device and the second housing element is moved in axial direction with respect to the tubing. The coupling element can thus allow that the first housing element is held by the second housing element, when the second housing element is removed. This can ensure that the first housing element will not stick with either one of the tubing or fluidic device, when opening the fitting element and separating the tubing from the fluidic device, so that the first housing element can removed from the fluidic device (e.g. a receiving cavity thereof).

The gripping piece may further comprises a grip force distributor configured to transform an axial force, which is provided in an axial direction with respect to the tubing, into a plurality of individual grip force components. Each grip force component is exerting on the tubing spaced apart in the axial direction from another grip force component. The plurality of individual grip force component result in the grip force.

The coupling element may be configured to provide a hooking between the first housing element and the second housing element.

An embodiment of the present invention comprises a fitting configured for coupling a tubing to a fluidic device. The fitting comprises a fitting element having the tubing, a first sealing element, and a second sealing element. The fluidic device comprises a receiving cavity configured for receiving the fitting element. Upon coupling of the tubing to the fluidic device, the first sealing element provides a first sealing stage at a front side of the tubing where the tubing is pressing to a contact surface within the receiving cavity. The second sealing element provides a second sealing stage for sealing the receiving cavity along a side of the tubing within the receiving cavity. Such fitting provides a two-stage sealing as aforediscussed, and may thus provide a chromatographic sealing by the first sealing element at the front side of the tubing and a system sealing by the second sealing stage. The second sealing stage thus seals an interspace between the first and second sealing stages.

An embodiment of the present invention comprises a fluid separation system configured for separating compounds of a sample fluid in a mobile phase. The fluid separation system comprises a mobile phase drive, such as a pumping system, configured to drive the mobile phase through the fluid separation system. A separation unit, which can be a chromatographic column, is provided for separating compounds of the sample fluid in the mobile phase. The fluid separation system further comprises a fitting element and/or fitting as disclosed in any of the aforementioned embodiments for coupling a tubing (provided the conducting the mobile phase) to a fluidic device in such fluid separation system. The fluid separation system may further comprise a sample injector configured to introduce the sample fluid into the mobile phase, a detector configured to detect separated compounds of the sample fluid, a collector configured to collect separated compounds of the sample fluid, a data processing unit configured to process data received from the fluid separation system, and/or a degassing apparatus for degassing the mobile phase. The fluidic device to which the tubing is or can be coupled can be any of such devices, and plural of such fittings or fitting elements may be used within such fluid separation system.

Embodiments of the present invention might be embodied based on most conventionally available HPLC systems, such as the Agilent 1290 Series Infinity system, Agilent 1200 Series Rapid Resolution LC system, or the Agilent 1100 HPLC series (all provided by the applicant Agilent Technologies—see www.agilent.com—which shall be incorporated herein by reference).

One embodiment comprises a pumping apparatus having a piston for reciprocation in a pump working chamber to compress liquid in the pump working chamber to a high pressure at which compressibility of the liquid becomes noticeable.

One embodiment comprises two pumping apparatuses coupled either in a serial or parallel manner. In the serial manner, as disclosed in EP 309596 A1, an outlet of the first pumping apparatus is coupled to an inlet of the second pumping apparatus, and an outlet of the second pumping apparatus provides an outlet of the pump. In the parallel manner, an inlet of the first pumping apparatus is coupled to an inlet of the second pumping apparatus, and an outlet of the first pumping apparatus is coupled to an outlet of the second pumping apparatus, thus providing an outlet of the pump. In either case, a liquid outlet of the first pumping apparatus is phase shifted, preferably essentially 180 degrees, with respect to a liquid outlet of the second pumping apparatus, so that only one pumping apparatus is supplying into the system while the other is intaking liquid (e.g. from the supply), thus allowing to provide a continuous flow at the output. However, it is clear that also both pumping apparatuses might be operated in parallel (i.e. concurrently), at least during certain transitional phases e.g. to provide a smooth(er) transition of the pumping cycles between the pumping apparatuses. The phase shifting might be varied in order to compensate pulsation in the flow of liquid as resulting from the compressibility of the liquid. It is also known to use three piston pumps having about 120 degrees phase shift.

The separating device preferably comprises a chromatographic column providing the stationary phase. The column might be a glass or steel tube (e.g. with a diameter from 50 μm to 5 mm and a length of 1 cm to 1 m) or a microfluidic column (as disclosed e.g. in EP 1577012 A1 or the Agilent 1200 Series HPLC-Chip/MS System provided by the applicant Agilent Technologies, see e.g. http://www.chem.agilent.com/Scripts/PDS.asp?IPaqe=38308). For example, a slurry can be prepared with a powder of the stationary phase and then poured and pressed into the column. The individual components are retained by the stationary phase differently and separate from each other while they are propagating at different speeds through the column with the eluent. At the end of the column they elute one at a time. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are micro-porous for an increased surface, though in EBA a fluidized bed is used.

The mobile phase (or eluent) can be either a pure solvent or a mixture of different solvents. It can be chosen e.g. to minimize the retention of the compounds of interest and/or the amount of mobile phase to run the chromatography. The mobile phase can also been chosen so that the different compounds can be separated effectively. The mobile phase might comprise an organic solvent like e.g. methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The fluid is preferably a liquid but may also be or comprise a gas and/or a supercritical fluid (as e.g. used in supercritical fluid chromatography—SFC—as disclosed e.g. in U.S. Pat. No. 4,982,597 A).

The pressure in the mobile phase might range from 2-200 MPa (20 to 2000 bar), in particular 10-150 MPa (100 to 1500 bar), and more particular 50-120 MPa (500 to 1200 bar).

The HPLC system might further comprise a sampling unit for introducing the sample fluid into the mobile phase stream, a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies, under www.agilent.com which shall be in cooperated herein by reference.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied in or by the control unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s). The illustration in the drawing is schematically.

FIG. 1 shows in schematic view a liquid separation system 10, in accordance with embodiments of the present invention, e.g. used in high performance liquid chromatography (HPLC).

FIGS. 2 and 3A-3C illustrate in cross-sectional view embodiments of a fitting 100.

FIGS. 4A-4D show different embodiments of the grip force distributor 200.

FIGS. 5A-5D illustrate other embodiments according to the present invention.

FIGS. 6A-6C illustrate force distribution profiles in axial direction as provided by different gripping pieces 108.

### DETAILED DESCRIPTION

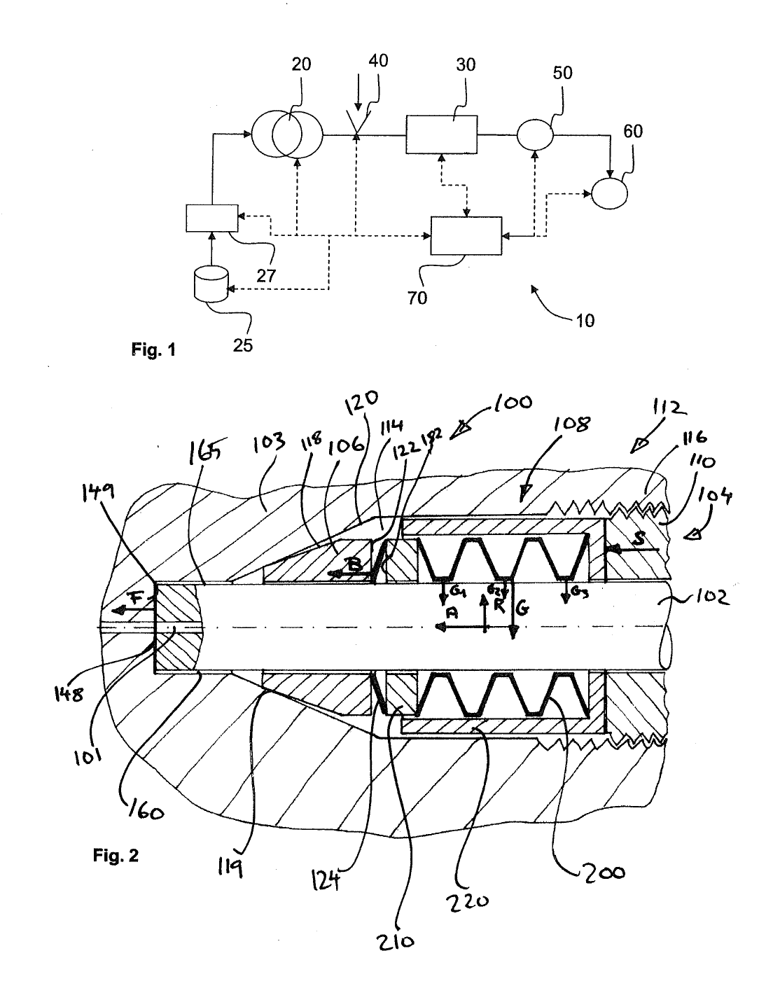

Referring now in greater detail to the drawings, FIG. 1 depicts a general schematic of a liquid separation system 10. A pump 20 receives a mobile phase from a solvent supply 25, typically via a degasser 27, which degasses and thus reduces the amount of dissolved gases in the mobile phase. The pump 20—as a mobile phase drive—drives the mobile phase through a separating device 30 (such as a chromatographic column) comprising a stationary phase. A sampling unit 40 can be provided between the pump 20 and the separating device 30 in order to subject or add (often referred to as sample introduction) a sample fluid into the mobile phase. The stationary phase of the separating device 30 is configured for separating compounds of the sample liquid. A detector 50 is provided for detecting separated compounds of the sample fluid. A fractionating unit 60 can be provided for outputting separated compounds of sample fluid.

While the mobile phase can be comprised of one solvent only, it may also be mixed from plural solvents. Such mixing might be a low pressure mixing and provided upstream of the pump 20, so that the pump 20 already receives and pumps the mixed solvents as the mobile phase. Alternatively, the pump 20 might be comprised of plural individual pumping units, with plural of the pumping units each receiving and pumping a different solvent or mixture, so that the mixing of the mobile phase (as received by the separating device 30) occurs at high pressure and downstream of the pump 20 (or as part thereof). The composition (mixture) of the mobile phase may be kept constant over time, the so called isocratic mode, or varied over time, the so called gradient mode.

A data processing unit 70, which can be a conventional PC or workstation, might be coupled (as indicated by the dotted arrows) to one or more of the devices in the liquid separation system 10 in order to receive information and/or control operation. For example, the data processing unit 70 might control operation of the pump 20 (e.g. setting control parameters) and receive therefrom information regarding the actual working conditions (such as output pressure, flow rate, etc. at an outlet of the pump). The data processing unit 70 might also control operation of the solvent supply 25 (e.g. setting the solvent/s or solvent mixture to be supplied) and/or the degasser 27 (e.g. setting control parameters such as vacuum level) and might receive therefrom information regarding the actual working conditions (such as solvent composition supplied over time, flow rate, vacuum level, etc.). The data processing unit 70 might further control operation of the sampling unit 40 (e.g. controlling sample injection or synchronization sample injection with operating conditions of the pump 20). The separating device 30 might also be controlled by the data processing unit 70 (e.g. selecting a specific flow path or column, setting operation temperature, etc.), and send—in return—information (e.g. operating conditions) to the data processing unit 70. Accordingly, the detector 50 might be controlled by the data processing unit 70 (e.g. with respect to spectral or wavelength settings, setting time constants, start/stop data acquisition), and send information (e.g. about the detected sample compounds) to the data processing unit 70. The data processing unit 70 might also control operation of the fractionating unit 60 (e.g. in conjunction with data received from the detector 50) and provides data back.

For transporting liquid within the liquid separation system 10, typically tubings (e.g. tubular capillaries) are used as conduits for conducting the liquid. Fittings are commonly used to couple plural tubings with each other or for coupling a tubing to any device. For example, fittings can be used to connect respective tubings to an inlet and an outlet of the chromatographic column 30 in a liquid-sealed fashion. Any of the components in the fluid path (solid line) in FIG. 1 may be connected by tubings using fittings. While the fluid path after the column 30 is usually at low pressure, e.g. 50 bar or below, the fluid path from the pump 20 to the inlet of the column 30 is under high pressure, currently up to 1200 bar, thus posing high requirements to fluid tight connections.

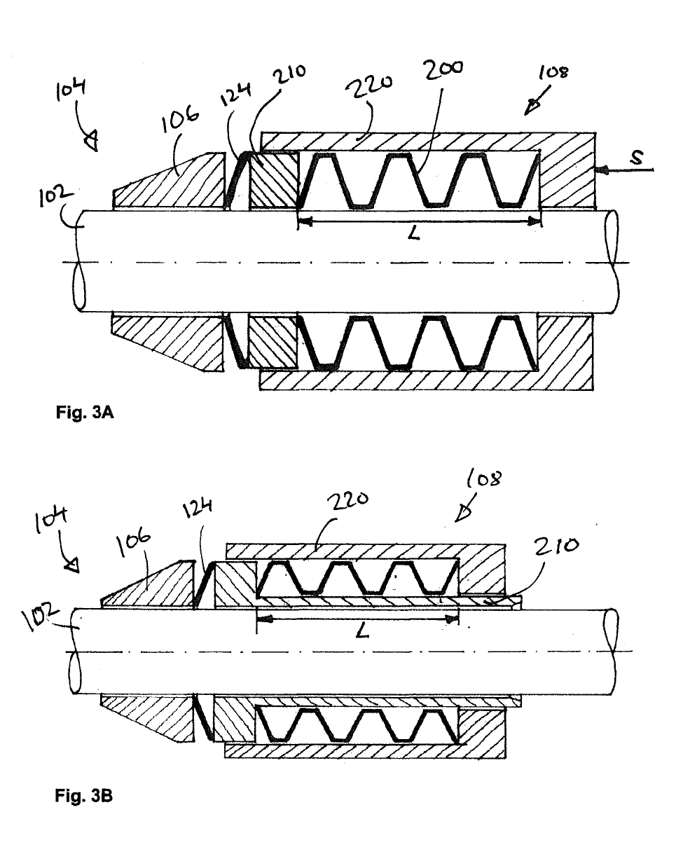

FIG. 2 shows—in a cross-sectional part view—an embodiment of a high pressure fitting 100 for coupling a tubing 102 having an inner fluid channel 101 for conducting liquid, e.g. the mobile phase with or without a sample fluid) to another fluidic device 103, such as chromatographic column 30 of FIG. 1. In the schematic view of FIG. 2, only the portion of the device 103 which is relevant for the coupling with the tubing 102 is depicted.

The fitting 100 comprises a male piece 104 having a front ferrule 106 (e.g. made of a polymer material) and having a gripping piece 108, which will explained later in more detail. In the embodiment of FIG. 2, the front ferrule 106 and the gripping piece 108 are separate elements but may also be integrally formed as one element. Each of the front ferrule 106 and the gripping piece 108 is slidable over the tubing 102 (which might have a metal or ceramic outer tubing or socket as known in the art). The male piece 104 further has a first joint element 110, which is also configured slidably on the tubing 102. In the embodiment of FIG. 2, the first joint element 110 is integrally coupled to the gripping piece 108 but may also be embodied as individual element. For mounting the fitting 100 on the tubing 102, the front ferrule 106, the gripping piece 108, and the first joint element 110 are slid on the tubing 102. The front ferrule 106, the gripping piece 108, and the first joint element 110 together constitute the male piece 104.

After having slid the male piece 104 over the tubing 102, a female piece 112 having a receiving cavity 114 (e.g. a recess) may be slid over the tubing 102 (from the left-hand side to the right-hand side of FIG. 2) or the male piece 104 may be inserted into the receiving cavity 114 of the female piece 112, dependent on the specific application and/or the specifics or type of the respective fluidic device 103. The receiving cavity 114 is configured for accommodating the front ferrule 106, the gripping piece 108, a part of the first joint element 110, and a part of the tubing 102. The receiving cavity 114 has a second joint element 116 configured to be joinable to or with the first joint element 110. The first and the second joint elements 110, 116 may be fastened to one another, e.g. by a screw connection.

A lumen of the front ferrule 106 is dimensioned for accommodating the tubing 102 with clearance. A lumen of the gripping piece 108 is dimensioned for accommodating the tubing 102 with clearance. The first joint element 110 also has a lumen configured for accommodating the tubing 102 with clearance.

The gripping piece 108 is configured such that upon joining the first joint element 110 to the second joint element 116, the gripping piece 108 exerts in axial direction (as indicated by axis A) a pressing force B on the front ferrule 106 to provide a sealing between the front ferrule 106 and the female piece 112. Simultaneously, upon joining the gripping piece 108 exerts in radial direction (as indicated by axis R) a grip force G between the male piece 104 and the tubing 102 (as will be further explained later). In addition to the gripping force G on the tubing 102, the gripping piece 108 exerts a front force F on the tubing 102 in axial direction A, which presses the tubing 102 against a contact surface of the receiving cavity 114 to provide a front-sided sealing of the tubing 102. The pressing force B as well as the front force F are in axial direction A (or parallel thereto), parallel to an extension of the tubing 102, whereas the grip force G is in radial direction R which is perpendicular to the extension of the tubing 102. With the grip force G, the gripping piece 108 provides a positive locking force between the male piece 104 and the tubing 102 and prevents the tubing 102 from laterally sliding after having fixed the two joint elements 110, 116 to one another.

As can be taken from FIG. 2, the front ferrule 106 has a conically tapered front part 118 shaped and dimensioned to correspond to a conical portion 120 of the receiving cavity 114 of the female piece 112. Thus, a form closure between the conical front part of the receiving cavity 114, on the one hand, and the conically tapered front part 118 of the front ferrule 106 may be achieved. The front ferrule 106 has a back part 122, which may be conically tapered (not shown here) and also arranged vertically or upright, and may be shaped and dimensioned to correspond to a slanted annular front spring 124 of the gripping piece 108. Upon exertion of the pressing force P, the slanted annular front spring 124 may be bent and will thus provide the pressing force B to be elastic and spring-biased. Upon joining the first joint element 110 to the second joint element 116, the slanted annular front spring 124 is bent and promotes a forward motion of the front ferrule 106 towards a stopper portion 119 of the receiving cavity 114 of the female piece 112.

As will be explained later, the gripping piece 108 is configured to promote, upon joining the first joint element 110 to the second joint element 116, a forward motion of the tubing 102 towards a stopper portion 148 of the receiving cavity 114 of the female piece 112 providing a spring-loading force. The stopper portion 148 typically is provided by a contact surface of the receiving cavity 114 to which a front side 149 of the tubing 102 is abutting to.

The first joint element 110 is configured for being joined to the second joint element 116 by a screw connection allowing to move the first joint element 110 relative to the second joint element 116. An external thread in the first joint element 110 of the male piece 104 can be screwed into an internal thread of the female piece 112 (as indicated in FIG. 2). By fastening such screwing connection, the first joint element 110 exerts a force S on the gripping piece 108 when the first joint element 110 abuts to the gripping piece 108, which leads to (1) gripping between the gripping piece 108 and the tubing 102 under the influence of the gripping force G, (2) a front-sided sealing between the front side 149 of the tubing 102 and the receiving cavity 114 under the influence of the front force F, and (3) a side sealing between the front ferrule 106 and the receiving cavity 114 under the influence of the pressing force B.

The second joint element 116 thus moves relative to first joint element 110 as well as the gripping piece 108. The front ferrule 106 and the gripping piece 108 are configured to be moved in axial direction A only in order not to reduce the grip force G.

FIG. 2 shows a non-biased state of the fitting 100. In a sealed configuration, the side sealing is achieved between the front ferrule 106 and the female part 112, and the front sealing is achieved in between the front side 149 and the female part 112. The front side 149 of the tubing 102 may be provided with a (e.g. polymeric) coating in order to further reduce sample contamination by increasing the sealing performance between the front side 149 and the stopper portion 148. Another useful effect of the front sealing can be an equilibration and elimination of roughness in sealing surfaces or tilt failures induced from manufacturing.

In the following, the force transmission will be explained: After having slid the front ferrule 106 and the gripping piece 108 on the tubing 102, and after having slid the first joint element 110 onto the tubing 102, the first joint element 110 may be connected by screwing against the second joint element 116. At first, the front ferrule 106 will be pushed forward against the receiving cavity 114. After contacting the cavity 114, the front ferrule 106 stops and the gripping piece 108 experiences axial force/pressure from both sides: the first joint element 110 continues increasing pressure while travelling in axial direction A, the front ferrule 106 acts as a counterpart of a clamping device. The gripping piece 108 therefore can only shorten its overall axial length, while housing parts 210 and 220 come closer (as will explained later in more detail), thus leading to the grip force G. This converts the gripping piece 108 into a biased state, so that grip is generated between the tubing 102 and the gripping piece 108. As the grip force increases, the axial forces B and F longitudinal to the capillary axis increase analog and to provide the front and side sealing.

Turning now in greater detail to the gripping piece 108. As already illustrated, the gripping piece 108 is configured to exert—upon coupling of the tubing 102 to the fluidic device 103—the grip force G between the male piece 104 of the fitting 100 and the tubing 102. For that purpose, the gripping piece 108 comprises a grip force distributor 200 configured to transform the axial force S, provided in the axial direction A with respect to the tubing 102, into a plurality of individual grip force components Gᵢ. In the example of FIG. 2 three individual grip force components G₁, G₂, and G₃ are indicated. Each grip force component Gᵢ is exerting in radial direction on the tubing 102 and is spaced apart in the axial direction from another grip force component. The plurality of individual grip force components Gᵢ result in the grip force G.

In the embodiment of FIG. 2, the front spring 124 is provided as individual component, but may also be an integral part of the gripping piece 108. As explained above, the front spring 124 (also) causes the pressing force B to be spring-loaded in order to elastically seal the front ferrule 106 to the side 120. The front spring 124 may be omitted in case either the pressing force B does not have to be spring-biased or the grip force distributor 200 is configured also to provide an elastic force in the axial direction A. In the latter case, a front side 182 of the gripping piece 108 can abut directly to the front ferrule 106. Alternatively, the front ferrule 106 can be provided as an integral part of the gripping piece 108, and the back part 122 of the front ferrule 106 may directly be in contact with the grip force distributor 200

While the front sealing at the front side 149 may be sufficient in certain applications, it may not be sufficient in particular for high pressure applications, for example when applying fluid pressure within the flow path of the tubing 102, e.g. in the range of 100-1500 bar, dependent on the materials used in the components connecting at the front side of the fitting. The side sealing by the front ferrule 106 provides the required high pressure sealing. The gripping piece 108 presses—upon coupling of the tubing 102 to the fluidic device 103—against the region 148. This closes and seals an interspace (e.g. void, cavity, hollow space) 160 around the front portion of the tubing 102 extending from the front side 149 over a lateral side 165 until the region where the front ferrule 106 seals against the side 120. Having a two-stage sealing also provides an additional design parameter in balancing the requirements of (1) adapting to the geometry of the contacting areas and (2) a degree of deformation in particular of the flow path (as a result from applying a high contact pressure). For example, the first stage of sealing provided by the front sealing at the front side 149 might be purposely designed to seal against a lower pressure only for the benefit of limiting deformation and thus constriction in the flow path.

During pressurization of the flow path 101 in the tubing 102, when increasing fluid pressure to a target system pressure, liquid might leak through the primary front sealing stage provided at the front side 146 into the interspace 160. By designing the (secondary) side sealing stage provided by the front ferrule 106 to fully seal against the maximum pressure within the flow path 101, liquid may fill the interspace 160 until the pressure difference between the system pressure and the pressure within the interspace 160 reaches the sealing pressure capability of the (primary) front sealing. Since the front sealing can be optimized to the capability for the optimal pressure difference, the side sealing can be optimized to the system pressure required. The split in two functional or cascaded pressure drops as achieved by a primary and a secondary sealing e.g. allows the primary sealing design to be kept unmodified while the system pressure requirements can be solved within the secondary sealing.

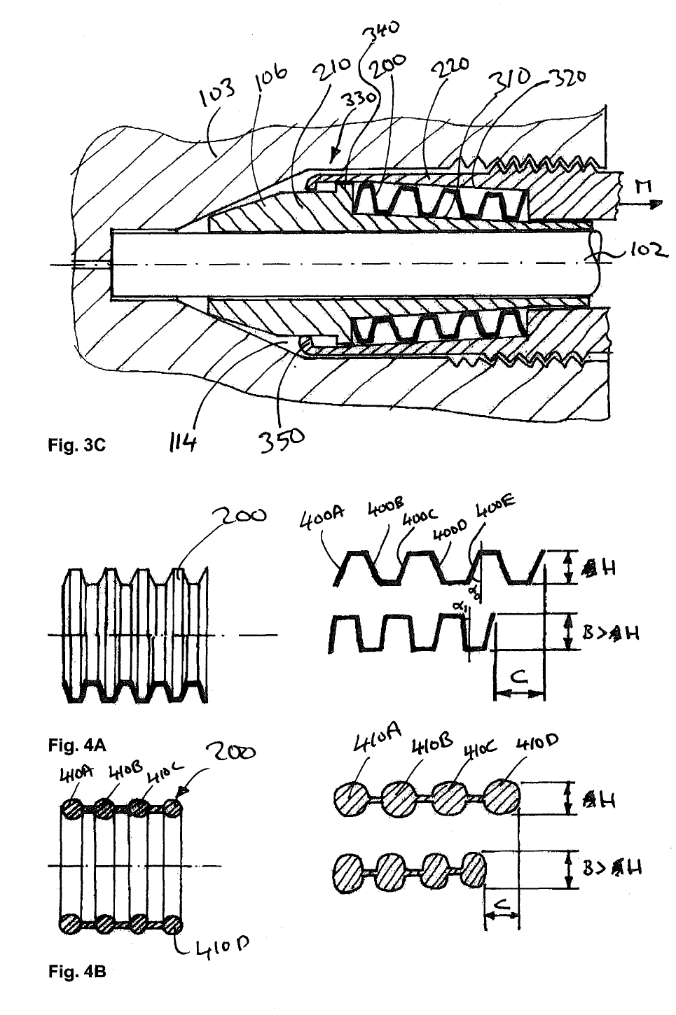

FIGS. 3A-3C show alternative embodiments of components of the fitting 100. Only the features differing from FIG. 2 shall be explained the following. The examples of FIGS. 3A-3B only show the male piece 104 and the tubing 102, while the female piece 112 of the fluidic device 103 has been omitted for the sake of simplicity.

The embodiment of FIG. 3A substantially represents the embodiment shown in FIG. 2 and shows a partial view thereof, with a slight difference in the embodiment of the grip force distributor 200. In both embodiments of FIGS. 3A and 2, the grip force distributor 200 is housed by a first housing element 210 and a second housing element 220 as individual component.

The embodiment of FIG. 3B distinguishes from FIG. 3A in that the first housing element 210 also houses the grip force distributor 200 at its lower side towards the tubing 102, thus providing a fully closed housing for the grip force distributor 200. This provides a further degree of freedom in the design of the gripping piece 108, for example it allows that another and/or a further surface finish or structure (e.g. gripping dents) or another and/or different hardness of material can be provided in contact with the gripping surface. The function of the grip force distributor 200 can be reduced to force transmission only, while e.g. shape, functionality, material, and manufacturing of the different components can be adjusted to an optimum.

Under the influence of the axial force S and with the front ferrule 106 being stopped when reaching the stopper portion 119, the second housing element 220 moves relative to the first housing element 210, thus decreasing an axial elongation L of the housing for the grip force distributor 200. The variation of the axial elongation L mainly depends on the position of the stopper portion 119 as well as the elasticity in particular of the spring loaded components such as the front spring 124 and the grip force distributor 200. Another factor can be related to tolerances of the parts, for example variations in diameter of the tubing 102 from tubing to tubing, which in HPLC applications are typically in a range of some hundreds of millimeter.

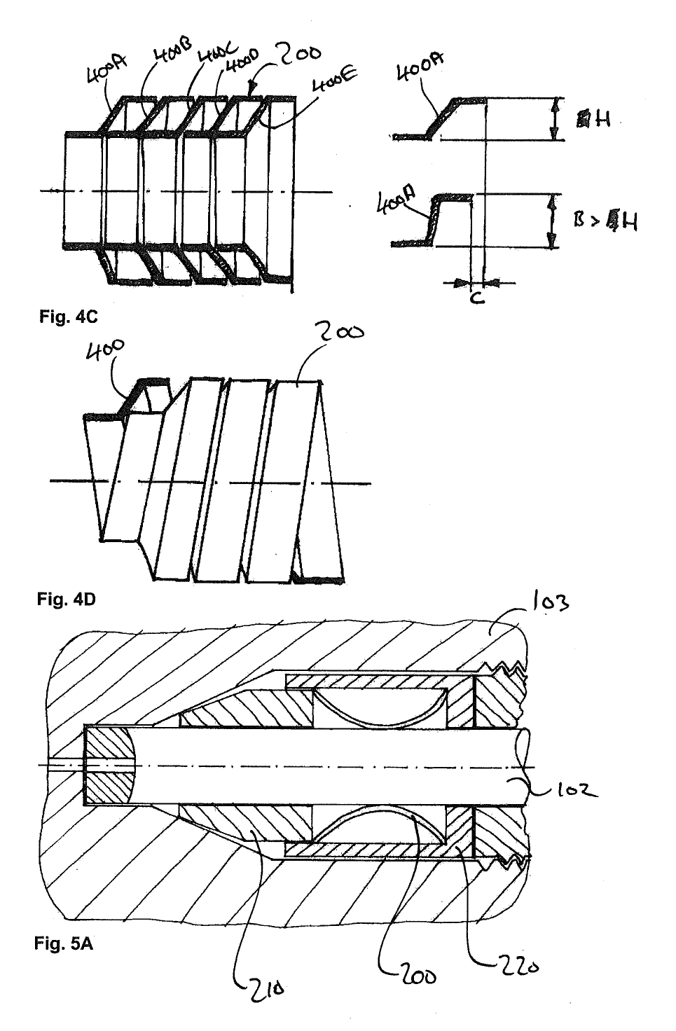

In the embodiments of FIGS. 2 and 3, the grip force distributor 200 is embodied as an elastic spring element, which is configured to vary its dimension in the radial direction R (cf. FIG. 2) when the axial elongation L is varied. This will be explained later with respect to FIG. 4A. When the axial elongation L is decreased, the radial dimension of the grip force distributor 200 increases, thus leading to the individual grip force component Gi where the grip force distributor 200 abuts either directly to the tubing 102 or to the first housing element 210 or to the second housing element 220 (when being provided between the grip force distributor 200 and the tubing 102).

The embodiment of FIG. 3C substantially corresponds to the representation of FIG. 2. In this embodiment of FIG. 3C, the front ferrule 106 is provided as an integral part of the first housing element 210. In accordance with the embodiment of FIG. 3B, the first housing element 210 fully extends over the axial elongation of the grip force distributor 200 and even between the second housing element 220 and the tubing 102, so that the second housing element 220 can slide over the first housing element 210.

In the embodiment of FIG. 3C, a surface 310 where the grip force distributor 200 abuts to the first housing element 210 is provided to be angled with respect to the axial elongation A (cf. FIG. 2) of the tubing 102. A surface 320 of the second housing element 220 shall also be angled, preferably in accordance with the surface 310. Such conical shaping of the first and/or the second housing elements 210 and 220 can provide an additional degree of freedom in designing and controlling the grip force, in particular by providing a radial bias. The axial movement of first housing element 210 towards the second housing element 220 results both in a reduction of available space for element 200 in axial direction and a reduction of space in radial direction simultaneously. This leads to a compression in axial and radial direction at the same time and therefore to an increased compression over the same movement of the second housing element compared with the arrangement in FIG. 3B.

The second housing element 220 in the embodiment of FIG. 3C further distinguishes from the embodiment of FIG. 2 in that it also incorporates the first joint element 110. Accordingly, the second housing element 220 in the embodiment of FIG. 3C provides two different functions: One by providing a axially movable housing (comparable to the embodiment of the second housing element 220 in FIG. 2) and the other by joining with the second joint element 116 (comparable to the embodiment of the first joint element 110 in FIG. 2) which rotates and moves in axial direction. The sloped surfaces of the elements 210 and 220 are preferably provided to have the same tilt, but different tilts may also be provided as a further degree of freedom in the design.

The embodiment of FIG. 3C further comprises a coupling element 330 configured for coupling the first housing element 210 with the second housing element 220, when the fitting 100 will be opened again and the second housing element 220 is moved in axial direction as indicated by arrow M. In the embodiment of FIG. 3C, the first housing element 210 comprises a first protrusion 340, and the second housing element 220 comprises a second protrusion 350, each of which which may be embodied as flange, dog plate, grab, deformation, or any other suitable type or feature as readily known in the art. When decoupling the fitting 100, the second housing element 220 relatively moves in the direction of arrow M, while the first housing element 210 might still stick to the tubing 102 as result of the axial force S. However, when the protrusion 350 hooks into the protrusion 340, the first housing element 210 will be drawn off from the receiving cavity 114 and preferably also from the tubing 102.

FIGS. 4A-4D show different embodiments of the grip force distributor 200. In FIG. 4A the grip force distributor 200 is embodied as a corrugated bellow and comprises a plurality of angular elements 400A-400E (cross section view depicted enlarged on the right hand side of FIG. 4A). Each angular element 400A-400E, when being housed by the gripping piece 108, provides an angle α with respect to the radial direction R (cf. FIG. 2). When the grip force distributor 200 is compressed in axial direction A, an angle α₀ with respect to the radial direction R is decreased to a smaller angle α₁, as indicated in the schematic drawing on the right hand side FIG. 4A. This applies accordingly to each of the angular elements 400A-400E. Accordingly, the dimension or lateral extension in radial direction R increases when the grip force distributor 200 is compressed in axial direction A, as indicated in FIG. 4A by the compressed height B being larger than the initial height H. Accordingly, by compressing the grip force distributor 200 in axial direction A, the angular elements will come closer and the overall length of the grip force distributor 200 in axial direction will be shorten by the length C, as indicated by dimension C in FIG. 4A. The lateral dimension in radial direction R of the grip force distributor 200 increases, thus increasing the individual grip force components Gᵢ and consequently the resulting grip force G where the grip force distributor 200 abuts to the tubing 102 or the first housing elements 210. It is clear that by releasing compression C of the grip force distributor 200, the lateral dimension in radial direction R of the grip force distributor 200 will decreases in turn, thus decreasing the individual grip force components Gᵢ.

The explanation with respect to the representation on the right hand side of FIG. 4A applies, mutatis mutandis, also to the embodiments of the grip force distributor 200 as shown in FIGS. 2 and 3.

FIG. 4B shows a different embodiment of the grip force distributor 200 comprising a plurality of fluid filled rings 410A-410D. The structure (rings plus connector) can be made e.g. of rubber material or another solid, but flexible material. Alternatively, a mixture of different components made from different materials, for example rings made of flexible material and connectors rigid, or vice versa, may be used. The rings 410A, 410 B, 410C, 410D can be made of different materials for different grip forces. That can be useful to adjust grip forces Gⱼ. It can also be used to cascade the grip force action in sequential order e.g. when compressing grip force distributor 200 from FIG. 4B The grip force distributor 200 can be mounted of separate rings and need not be one integral structure. Compressing the structure FIG. 4B in the direction of arrow C also leads to an increase in the lateral height in radial direction R, as indicated by the compressed height B being larger than the initial height H. The rings 410 might be filled with a gas. Accordingly, the rings 410 might be provided by an adequate material such as silicone

FIG. 4C shows an embodiment of a sheet metal packet for the grip force distributor 200. In accordance with the principle explained in FIG. 4A, the angular walls 400A-400E lead to an increased compressed radial height B with respect to the initial radial height H when compressing in the direction of arrow C. The sheet metal package is assembled using several equally shaped and configured elements or several elements with slightly different shape to adjust the grip force distributor function.

The embodiment of FIG. 4D shows the grip force distributor 200 as a spiral coil, with the principle of the angular walls 400 as illustrated above applying here accordingly.

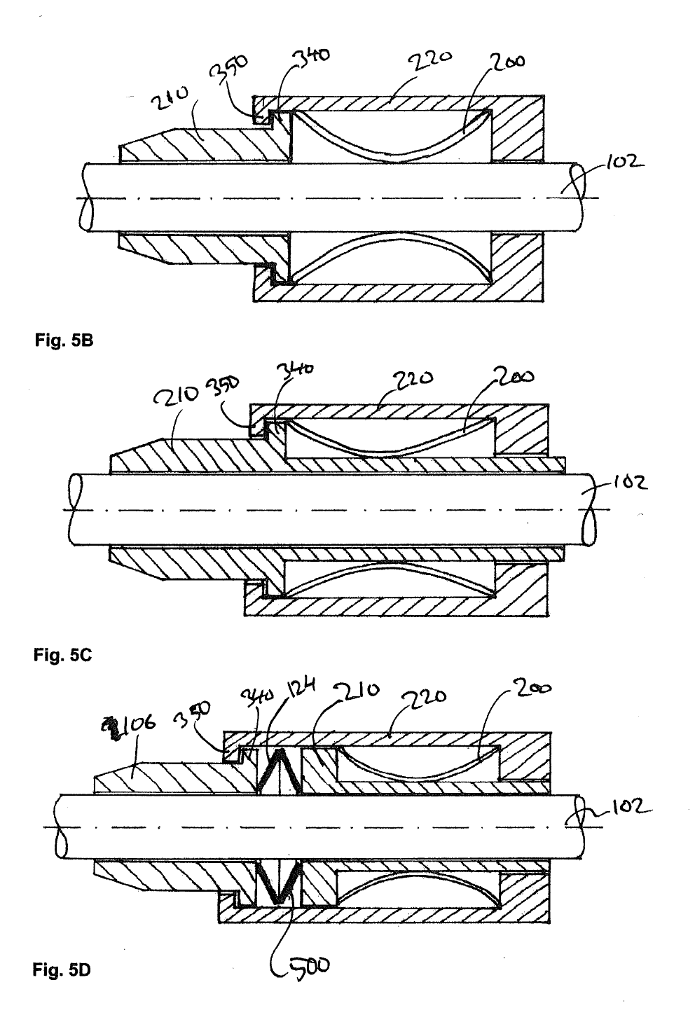

FIGS. 5A-5D illustrate other embodiments according to the present invention. In the embodiment of FIG. 5A, the first housing element 210 also incorporates the front ferrule 106 as integral part in accordance with the embodiment of FIG. 3C. The grip force distributor 200 is simplified here as a general elastic spring element, which can be embodied in accordance with the aforementioned embodiments or e.g. an elastic spring element as schematically depicted in FIG. 5A. Further, instead of the integral embodiments shown in FIGS. 2-4, the grip force distributor 200 may also be comprised by a plurality of individual elements acting together.

In the embodiment of FIG. 5B, the first housing element 210 comprises the first protrusion 340, and the second housing element 220 comprises the second protrusion 350 in accordance with the aforedescribed, e.g. recess and flange.

The embodiment of FIG. 5C corresponds to the embodiment of FIG. 5B with the first housing element 210 further extending in axial direction A and between the grip force distributor 200 and the second housing element 220.

In the embodiment of FIG. 5D, the front ferrule 106 is separated from the first housing element 210, with the protrusion 340 now being embodied on the front ferrule 106. Further, an additional angular spring 500 in combination to the spring 124 is provided, which may be positioned in opposite direction as indicated in FIG. 5D. This can be of advantage to maintain the elastic force F on the front ferrule 106 e.g. in case of variations in temperature and/or mechanical dimensions.

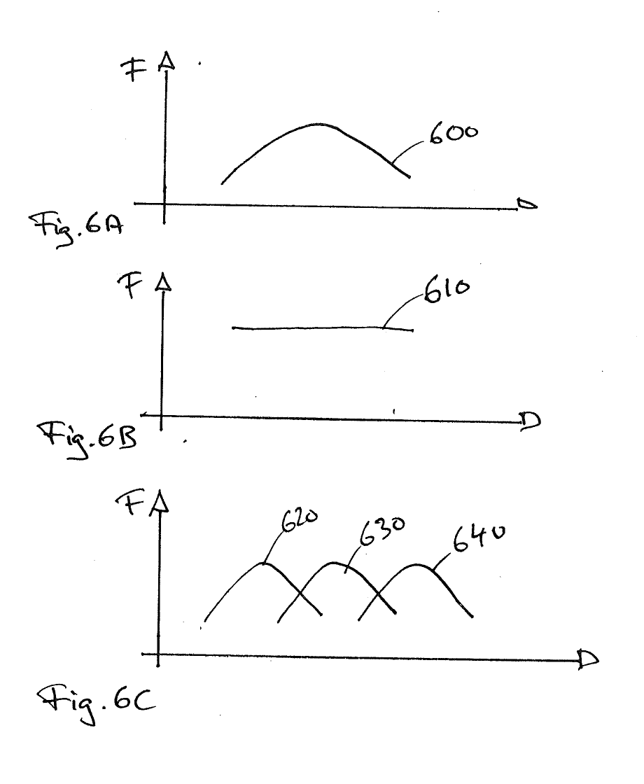

FIGS. 6A-6C schematically illustrate force distribution profiles in axial direction as provided by different gripping pieces 108. In FIG. 6A, the gripping piece 108 shall be embodied by the grip force distributor 200 as depicted in FIG. 5. The force distribution shows one peak where the grip force distributor 200 abuts to the tubing 102 (or the first housing element 210 if provided between the grip force distributor 200 and the tubing 102). The breadth of the peak 600 mainly depends on the size and shape where the grip force distributor exerts the grip force G onto or towards the tubing 102. FIG. 6B illustrates an embodiment where the grip force distributor 200 provides a plurality of individual grip force components which are closely spaced apart in axial direction, thus resulting in a substantially homogeneous force distribution profile 610. FIG. 6C illustrates an embodiment with three grip force components spaced apart with distances significantly larger than in the embodiment of FIG. 6B. Accordingly, the force distribution profile of FIG. 6C shows three individual peeks 620, 630 and 640, which however provide a wider force distribution profile than the single peak profile of FIG. 6A. It is clear that other profiles can be achieved by adequately designing the grip force distributor 200

The embodiments of the fitting 100 as shown in the aforegoing are in particular suitable to a allow plural fitting cycles of the tubing 102, so that the tubing 102 can be securely fitted plural times to either the same of different devices 103.

1. A fitting element, in particular for an HPLC application, configured for providing a fluidic coupling of a tubing to a fluidic device, the fitting element comprising:
a gripping piece configured to exert, upon coupling of the tubing to the fluidic device, a grip force between the fitting element and the tubing, and
wherein the gripping piece comprises a grip force distributor configured to transform an axial force, provided in an axial direction with respect to the tubing, into a plurality of individual grip force components, each grip force components is exerting on the tubing spaced apart in the axial direction from another grip force component, and the plurality of individual grip force components result in the grip force.

2. The fitting element of claim 1, wherein the grip force distributor comprises:
an elastic spring element configured for varying its dimension in a radial direction, with respect to the tubing, under the influence of the axial force.

3. The fitting element of claim 2, comprising at least one of:
the elastic spring element is configured for varying its lateral extension in the radial direction under the influence of the axial force;
the elastic spring element comprises a plurality of angular elements, each angular element being arranged in an angle with respect to the radial direction and configured to decrease the angle under the influence of an increasing axial force;
the elastic spring element comprises a mechanical spring element, in particular at least one of a spring washer, a disk spring, a Belleville spring washer, a bellow, a corrugated bellow, a metal bellow, a gaiter, a coupled ring-structure, a sheet metal packet, a spiral coil;
the elastic spring element comprises a multiple spring configuration, preferably comprising two disk springs in parallel or mirrored.

4. The fitting element of claim 1, wherein the grip force distributor is made of or comprises at least one of:
an elastic ductile, non-floating material;
a metal, preferably at least one of spring steel, SST, Nickel;
an elastomer;
a gas volume in a cavity;
a liquid in a cavity;
a combination of plural of solid, gaseous, and liquid materials.

5. The fitting element of claim 1, comprising at least one of:
the grip force distributor is configured to provide the plurality of individual and spaced apart grip force components in a force distribution on the tubing;
the gripping piece comprises a housing for housing the grip force distributor.

6. The fitting element of claim 1, comprising:
a first housing element and a second housing element, each being an individual component with respect to the other, and both being configured to at least partly housing the gripping piece,

7. The fitting element of claim 6, wherein:
at least one of the first housing element and the second housing element comprises a coupling element configured to couple the first housing element and the second housing element when de-coupling the tubing from the fluidic device and moving the second housing element in an axial direction with respect to the tubing.

8. The fitting element of claim 1, wherein:
the gripping piece is configured for generating, upon coupling of the tubing to the fluidic device, a spring-biased force.

9. The fitting element of claim 8, comprising at least one of:
the spring-biased force is exerted in a radial direction of the tubing or parallel thereto;
the spring-biased force is exerted in the axial direction or parallel thereto;
the spring-biased force is generated by the grip force distributor.

10. The fitting element of claim 1, comprising:
a sealing piece configured to provide, upon coupling of the tubing to the fluidic device, a sealing between the sealing piece and the fluidic device.

11. The fitting element of claim 10, comprising at least one of:
the gripping piece is configured for exerting the spring-biased force in axial direction on the sealing piece in order to provide a spring-biased sealing between the sealing piece and the fluidic device;
the sealing piece is or comprises a front ferrule;
the gripping piece exerts a pressing force against the sealing piece;
the gripping piece exerts a pressing force against the sealing piece, the pressing force being at least partially caused by the grip force distributor;
the gripping piece exerts a spring-biased pressing force against the sealing piece;
the sealing piece is configured for sealing against a pressure in a fluid path of the tubing;
the sealing piece is slidable on the tubing at least before coupling of the tubing to the fluidic device;
the sealing piece is configured for sealing a receiving cavity of the fluidic device, when the receiving cavity receives the fitting element upon coupling of the tubing to the fluidic device.

12. The fitting element of claim 1, comprising:
a front sealing configured to provide, upon coupling of the tubing to the fluidic device, a sealing between a front side of the tubing coupling to the fluidic device and the fluidic device.

13. The fitting element of claim 1, comprising at least one of:
a first joint element configured for exerting the axial force on the grip force distributor upon coupling of the tubing to the fluidic device.

14. The fitting element of claim 13, comprising at least one of:
upon coupling of the tubing to the fluidic device, the first joint element is joint to a second joint element of the fluidic device;
upon coupling of the tubing to the fluidic device, the first joint element is joint to a second joint element of the fluidic device by a screw connection;
the first joint element is slidably on the tubing before coupling of the tubing to the fluidic device;
the first joint element partly houses the grip force distributor;

15. The fitting element of claim 1, wherein:
the fitting element is configured to be accommodated by a receiving cavity of the fluidic device.

16. The fitting element of claim 1, comprising at least one of:
the axial force results from coupling of the tubing to the fluidic device.
the grip force is in a radial direction with respect to the tubing;
the radial direction is substantially perpendicular to the axial direction;
the gripping piece is or comprises at least one of a back ferrule and a front ferrule;
the gripping piece is slidable on the tubing before coupling of the tubing to the fluidic device.

17. The fitting element of claim 1, comprising at least one of:
the tubing is made of or comprises at least one of a group consisting of a metal, stainless steel, titan, a plastic, a polymer, ceramic, glass, and quartz;
the tubing has a lumen having a diameter of less than 0.8 mm, particularly of less than 0.2 mm or down to 25 μm or less;
the tubing has one of a circular, elliptical, or rectangular shape;
the tubing is or comprises a capillary;
the tubing comprises an inner tubing and an outer tubing, the outer tubing surrounding the inner tubing;
the tubing comprises an inner tubing and an outer tubing, the outer tubing surrounding the inner tubing, the inner tubing being comprised of a different material than the outer tubing;
a socket surrounding the tubing.

18. A fitting element for an HPLC application, configured for providing a fluidic coupling of a tubing to a fluidic device, the fitting element comprising:
a gripping piece configured to exert, upon coupling of the tubing to the fluidic device, a grip force between the fitting element and the tubing, and
a first housing element and a second housing element, each being an individual component with respect to the other, and both being configured to at least partly housing the gripping piece,
wherein at least one of the first housing element and the second housing element comprises a coupling element configured to couple the first housing element and the second housing element when de-coupling the tubing from the fluidic device and moving the second housing element in an axial direction with respect to the tubing.

19. The fitting element of claim 18, comprising at least one of:
the gripping piece comprises a grip force distributor configured to transform an axial force, provided in an axial direction with respect to the tubing, into a plurality of individual grip force components, each grip force components is exerting on the tubing spaced apart in the axial direction from another grip force component, and the plurality of individual grip force components result in the grip force;
the coupling element is configured to provide a hooking between the first housing element and the second housing element.

20. A fitting configured for coupling a tubing to a fluidic device, the fitting comprising:
a fitting element, according to claim 1, configured for providing a fluidic coupling of the tubing to the fluidic device, and
wherein a receiving cavity of the fluidic device is configured for receiving the fitting element, and upon coupling of the tubing to the fluidic device the tubing is pressing to the receiving cavity and the fluid path of the tubing is connected to the fluid path of the fluidic device.

21. The fitting of claim 20, comprising at least one of:
the fluidic device is or comprises at least one of: a second tubing, an apparatus, an HPLC device, a fluid separation device, a fluid handling device, a measurement device;

22. A fluid separation system for separating compounds of a sample fluid in a mobile phase, the fluid separation system comprising:
a mobile phase drive, preferably a pumping system, configured to drive the mobile phase through the fluid separation system,
a separation unit, preferably a chromatographic column, configured for separating compounds of the sample fluid in the mobile phase, and
a fitting element according to claim 1 for coupling a tubing for conducting the mobile phase.

23. The fluid separation system of claim 22, further comprising at least one of:
a sample injector configured to introduce the sample fluid into the mobile phase;
a detector configured to detect separated compounds of the sample fluid;
a collection unit configured to collect separated compounds of the sample fluid;
a data processing unit configured to process data received from the fluid separation system;
a degassing apparatus for degassing the mobile phase.
